(19) United States
(12) Patent Application Publication
(10) Pub. No.: US 2009/0246085 A1
(43) Pub. Date: Oct. 1, 2009

(54) Liquid Handling System and Methods for Mixing and Delivering Liquid Reagents

(75) Inventors: Alexander Watson, Gloucester, MA (US); John Price, Boston, MA (US); Parris Wellamn, Reading, MA (US); John Kepler, Lexington, MA (US)

Correspondence Address: COOLEY GODWARD KRONISH LLP;ATTN: Patent Group, Suite 1100, 777 - 6th Street, NW, WASHINGTON, DC, 20001, US

(73) Assignee: HELICOS BIOSCIENCES CORPORATION, Cambridge, MA (US)

(21) Appl. No.: 12/059,960

(22) Filed: Mar. 31, 2008

(51) Int. Cl. B01L 3/00; B67C 9/00

(52) U.S. Cl. 422/100; 222/541.1; 422/102; 422/104; 141/329

(57) ABSTRACT

A liquid storage apparatus provides a safe and easy to use device for efficiently managing liquid reagents used in a variety of laboratory equipment. The liquid storage apparatus helps reduce the likelihood of accidents, allows for flexibility of experimental design, and helps maximize the use of chemical regents to prevent waste. The apparatus includes a plurality of containers with a pierceable septum interface at each end. The apparatus also includes a lower array of needles with each of the lower needles in the lower array of needles arranged to penetrate the bottom pierceable septum of a different one of the containers. The apparatus further includes a piercing device arranged to penetrate the top pierceable septum of a different one of the containers. Each of the piercing devices include a passageway so gas can flow into the pierced container.

### TECHNICAL FIELD

The present invention relates generally to the storage and handling of liquid reagents in microfluidic systems. More particularly, the present invention relates to liquid containers and cartridges, piercing devices, mixing and administration systems, and methods of storing and handling liquid reagents for use in single molecule sequencing applications.

### BACKGROUND INFORMATION

Fluidic systems are used in a variety of areas including biochemical analysis, medical diagnostics, analytical chemistry, chemical synthesis, and environmental monitoring. Microfluidic systems provide certain advantages in acquiring chemical and biological information. For example, microfluidic systems permit complicated processes to be carried out using small amounts of reagents.

In certain diagnostic equipment and systems, reagents are stored in containers with a needle pierceable septum at one end. Fluids can be extracted from these bottles in several ways. For example, the septum can be pierced with a short and a long needle. The long needle is designed to reach the bottom of the bottle to extract the liquid, and the short needle provides an air vent to replace the liquid with air as it is extracted from the bottle. A long needle causes safety concerns and requires complex mechanisms to protect and guide into the bottle. Another example of a method for extracting the liquid from these bottles is to provide a significant air volume above the liquid to only allow for low vacuum level buildup while extracting. This method has certain drawbacks as well because allowing even a small vacuum buildup in the bottle can introduce dispensing errors at selector valves in the liquid handling system. Furthermore, liquid storage systems and interfaces that use this method are difficult to manage.

### SUMMARY OF THE INVENTION

The present invention provides systems and methods for liquid reagent storage and handling. Systems and methods of the invention are useful in conjunction with any system in which reagent delivery is required, and are especially useful in apparatus for analyzing microfluidic volumes. Generally, the invention provides a safe and easy way to manage efficiently liquid reagents for use in a variety of laboratory equipment. The present invention helps reduce the likelihood of accidentals, allows for flexibility of experimental design, and helps maximize the use of chemical reagents to prevent waste.

In a particular embodiment, the invention features an apparatus comprising a plurality of containers. Each of the containers includes, a top pierceable septum and a bottom pierceable septum. The apparatus also includes a lower array of needles. Each of the lower needles in the lower array of needles is arranged to penetrate the bottom pierceable septum of a different one of the containers and each of the needles include a passage so the liquid can flow out of the pierced container. The apparatus further includes a piercing device arranged to penetrate the top pierceable septum of each of the containers. The piercing device includes a passageway that allows gas to flow into the pierced container to occupy the space created as the liquid flows out of the container.

In one aspect of the invention, the piercing device includes a housing that defines an internal region for receiving a container having a pierceable septum. The housing includes one or more slots to allow expansion of the housing when receiving a container. The housing also includes a septum piercing element affixed to the housing. The septum piercing element has a pointed tip and defines a passageway that allows gas to flow into the pierced container to occupy the space created as the liquid flows out of the container. One or more protrusions on the housing selectively engage an outer surface of the container to position and retain the container in the housing in an un-actuated position such that the septum piercing element does not pierce the septum prior to manipulation.

In an alternative embodiment, a subset of two or more of the containers can be selectively secured together to form a cartridge assembly. One of more of these cartridge assemblies can be used to streamline or simplify the process of loading and unloading liquid reagents. A further aspect of this embodiment allows for customized cartridge assemblies designed for specific applications so that the liquid in each container of the cartridge is used up at approximately the same time.

In another aspect of the invention, the lower array of needles includes non-coring needles with a closed sharpened end. These needles include an aperture in the side of the needle, which can be positioned slightly inside the bottom pierceable septum to maximize the utilization of the liquid reagents.

In a further aspect of the invention, the upper array of needles is fluidly coupled to a filter, ventilation system, check valve or an inert gas system. For a variety of reasons it may be important to regulate the flow of gas into, or out of the containers as the liquids are being withdrawn. Some reagents may give off toxic fumes or unpleasant odors while others may degrade in the presence of oxygen. Providing a partially or completely sealed system can help provide a safer work environment and prevent the liquid reagents from breaking down or altering their composition.

In yet another aspect of the invention, the liquid storage apparatus further includes a liquid level sensor. Analytical equipment utilizing the liquid reagents stored in the apparatus can be damaged if gasses are allowed to enter the other systems. One way of preventing this damage is to provide liquid level sensors for each individual container or for the entire apparatus that either notifies the user when the liquid level is getting low or shuts down the equipment. Various types of sensors can be used with the apparatus including, for example, ultrasonic, optical, capacitance level sensing.

The invention is especially useful in automated systems, as for example when robotics are desired to deliver reagents. Thus, a cartridge system comprising a plurality of reservoirs is loaded into an instrument comprising robotics for accessing and dispensing reagents as described above. Robotic systems can include a separate module of needles that can be replaced at intervals determined by a user.

The invention is also useful to effect on-time delivery of reagents, either under manual control or under the control of a computer or other electronic processor. Reagents can be accessed as needed and are isolated from environmental contaminants. In that regard, reagent dispensing bottles may be opaque, depending upon their contents.

Pierceable reagent containers of the invention may be used in various applications known to the skilled artisan, examples of which are described below.

### BRIEF DESCRIPTION OF THE DRAWINGS

For a fuller understanding of the nature and operation of various embodiments according to the present invention, reference is made to the following description taken in conjunction with the accompanying drawing figures which are not necessarily to scale and wherein like reference characters denote corresponding or related parts throughout the several views and wherein:

FIG. 1 is a schematic perspective view of an exemplary embodiment of a needle and container arrangement showing the containers in the process of being loaded;

FIG. 2A is a schematic perspective view of the needle and container arrangement of FIG. 1 showing the containers in the loaded position;

FIG. 2B is an enlarged schematic perspective view of the needle and container arrangement of FIG. 2A showing the lower needles pierced through the bottom pierceable septum of two of the containers;

FIG. 3A is a schematic perspective view of a Trocar needle for use in the lower array of needles of the needle and container arrangement of FIG. 1;

FIG. 3B is a schematic front view of the Trocar needle shown in FIG. 3A;

FIG. 4A is a schematic top view of a deflected tip needle for use in the upper array of needles of the needle and container arrangement of FIG. 1;

FIG. 4B is a schematic front view of the deflected tip needle shown in FIG. 4A;

FIG. 4C is a schematic side view of the deflected tip needles shown in FIG. 4A;

FIG. 5 is a schematic perspective view of a piercing device according to one exemplary embodiment of the present invention;

FIG. 6A is a schematic perspective view of a piercing device according to a second exemplary embodiment of the present invention;

FIG. 6B is a cross section view of the piercing device shown in FIG. 6A;

FIG. 6C is a an enlarged schematic perspective view of the piercing element shown in FIG. 6B;

FIG. 6D is a side elevation view of the piercing device shown in FIG. 6A;

FIG. 7A is a schematic perspective view of the piercing element shown in FIG. 6A attached to the top end of a container in an un-actuated position;

FIG. 7B is a schematic perspective view of the piercing element shown in FIG. 6A attached to the top end of a container in an actuated position;

FIG. 8 is a schematic perspective view of the needle and container arrangement of FIG. 1 showing the cover in a closed position;

FIG. 9 is a schematic perspective view of a syringe pump system according to one exemplary embodiment of the present invention;

FIG. 10A is a cross-section front view of an individual container of the needle and container arrangement of FIG. 1 showing a lower needle pierced through the bottom pierceable septum;

FIG. 10B is a top view of an individual container of the needle and container arrangement of FIG. 1;

FIG. 11 is a schematic perspective view of an alternative exemplary embodiment of a needle and container arrangement with different sized containers;

FIG. 12A is a schematic view of an apparatus that can be used to perform analytical experimentation with an exemplary embodiment of needle and container arrangement shown in FIG. 1;

FIG. 12B is a schematic view of an apparatus that can be used to perform analytical experimentation with an exemplary embodiment of needle and container arrangement shown in FIG. 1 with its liquids compartment drawer in the open position;

FIG. 12C is a schematic view of a needle and container assembly of FIG. 1 integrated into a liquids compartment of the apparatus used to perform analytical experimentation shown in FIGS. 12A and 12B;

FIG. 12D is an enlarged schematic view of the needle and container assembly of FIG. 12C; and

FIG. 12E is a schematic view of the needle and container assembly of FIG. 12C showing the cover in an opened position.

### DESCRIPTION

Embodiments of the present invention are described below. It is, however, expressly noted that the present invention is not limited just to these disclosed embodiments. Various modifications not specifically detailed are within the scope of this disclosure. All relative descriptions herein such as top, bottom, left, right, up, and down are with reference to the figures, and thus should not be construed in a limiting sense. The present invention can be applied to liquid storage and handling systems for many types of analytical equipment such as, for example, flow cytometers and chemical analyzers. Further, the disclosed liquid storage and handling system can be used as part of a system for detecting single molecules by, for example, optical detection of single nucleotides.

As indicated above, the present invention relates to the storage and handling of liquid reagents in microfluidic systems. Embodiments of a fluidic system and apparatus according to the present invention generally streamline the analysis of biochemical assays. The system, devices, and methods enable simple and safe loading and unloading of reagent containers or cartridges, allow for more accurate discharge and mixing of reagent volumes, and maximizes the utilization of the liquid volume in each individual container or cartridge.

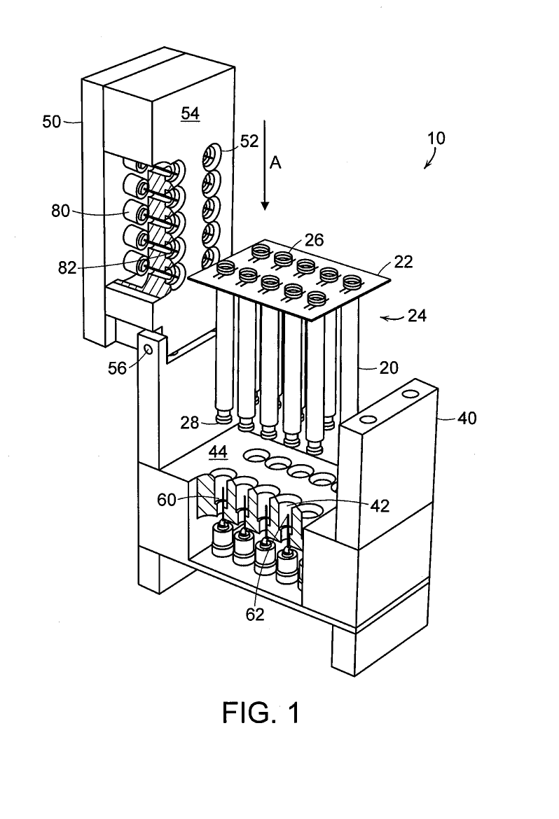

Referring now to FIG. 1, a liquid storage apparatus 10 includes a plurality of containers 20 filled with liquid reagents being loaded into a frame 40. The containers 20 are selectively secured to a tray carrier 22 thereby forming a cartridge assembly 24. Other means for arranging the plurality of containers 20 into a unitary cartridge assembly 24 will be apparent to one skilled in the art. In alternative embodiments, the containers 20 can be loaded into the frame 40 individually or in multiple cartridge assemblies. The containers 20 can be glass or a suitable plastic material such as acrylic, polycarbonate, or polypropylene. In some embodiments, the materials used in each container 20 can be the same or different from the other containers 20 depending on the liquid being stored, such that the liquid is not reactive with the container 20 material. Also, individual liquids may need to be stored in different thermal or atmospheric conditions and therefore thermal expansion characteristics may be an important consideration when selecting the container material.

Each container 20 includes a top pierceable septum 26 and a bottom pierceable septum 28. These septa 26, 28 can be made from any pliable material that allows penetration by a needle or piercing device and then seals the outside periphery of the needle or piercing device to prevent leakage. Examples of such materials are polytetrafluoroethylene (PTFE), fluorinated ethylene-propylene (FEP) and perfluoroalkoxy polymer resin (PFA), which are known generally by DuPont's brand name Teflon®. The septa 26, 28 can be the same or different depending on the desired application and/or the liquid being stored in each container. The septa 26, 28 can be secured to the container 20 in any of a number of ways including, for example, snap on, screw cap, mechanically fastened, heat welding, vibration welding, ultrasonically welding, or bonding with an adhesive.

The liquid storage apparatus 10 also includes a lower array of needles 60. Each of the needles 60 are disposed in a cavity 42 recessed into the bottom surface 44 of the frame 40. As the cartridge assembly 24 is being lowered into the frame 40 in the direction indicated by line A, the bottom pierceable septa 28 are received into the cavities 42. The cavities 42 can be slightly tapered with the widest part at the bottom surface 44 of the frame 40 to help guide the containers 20 into the cavities 42. The needles 60 are disposed in the cavities 42 such that the points 62 of the needles 60 are below the bottom surface 44 of the frame 40 to help prevent accidental sticks. The cavities 42 also help ensure proper alignment of the needles 60 in the center of each septum 28 prior to penetration.

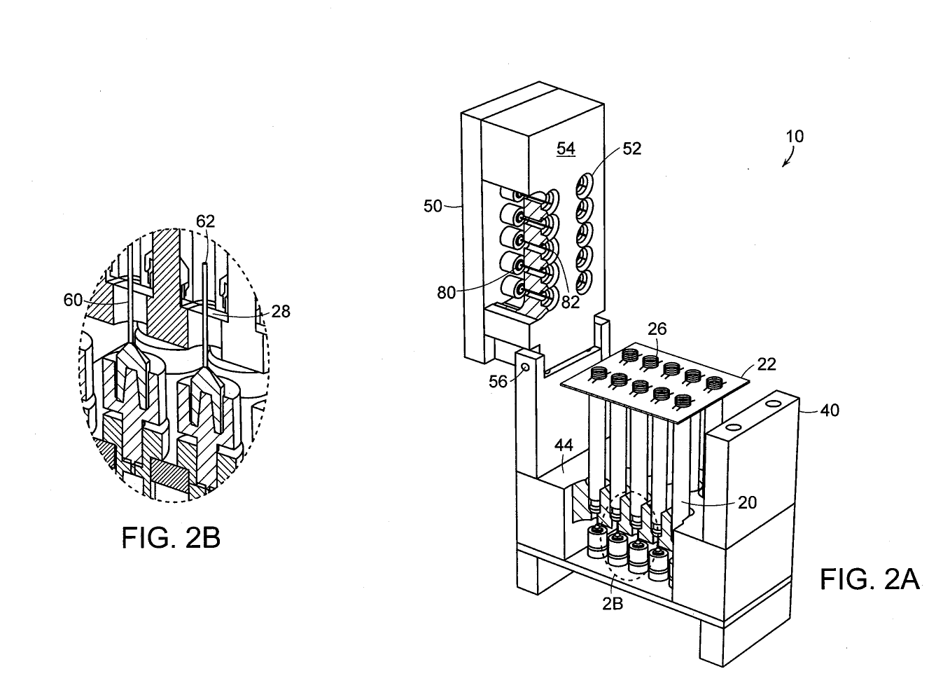

Referring now to FIGS. 2A and 2B, the containers 20 are shown partially loaded into the frame 40. Each of the needles 60 have pierced the bottom pierceable septum 28 of each of the containers 20 and is penetrating into the liquid reagent. Each of the needles 60 has a passageway allowing the liquid reagent in the pierced container 20 to flow out of the container 20 to a liquids mixing and handling system.

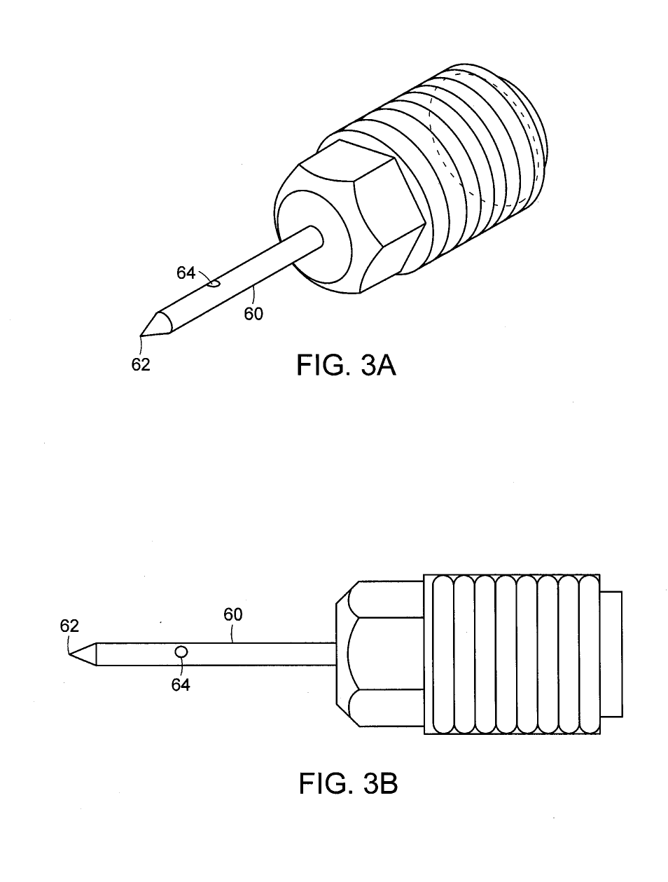

Liquid reagents used in certain analytical procedures are very expensive and therefore it is desirable to utilize as much of the liquid volume as possible to prevent waste. Referring now to FIGS. 3A and 3B, a Trocar needle for use in the lower array of needles 60 is shown. As shown, the needle 60 has a closed sharpened point 62 and an aperture 64 in the side of the needle 60 to allow the point 62 of the needle 60 to protrude into the container 20 a sufficient distance to pierce the septum 28, while also providing the outlet for the liquid in close proximity to the septum 28. Such an arrangement allows for maximum utilization of the liquid volume in each container 20. In alternative embodiments, the needles in the lower array of needles 60 can be any type of needle including, for example, a thoracentesis needles, Veress needles, or Huber needles. The needles 60 can be fabricated from stainless steel, titanium or other similarly rigid material in a range of sizes and lengths depending on the requirements of a particular application.

Referring now back to FIGS. 2A and 2B, the liquid storage apparatus 10 further includes an upper array of needles 80. Each of the needles 80 are disposed in a cavity 52 recessed into the bottom surface 54 of a cover 50 pivotally attached to the frame 40. The cavities 52 can be slightly tapered with the widest part at the bottom surface 54 of the cover 50 to help guide the containers 20 into the cavities 52. The needles 80 are disposed in the cavities 52 such that the points 82 of the needles 80 are below the bottom surface 54 of the cover 50. These cavities 52 are similar to the cavities 42 described above in relation to the frame 40 and perform substantially the same function, such as prevention of accidental sticks and ensuring proper alignment of the needles 80 in the center of each upper septum 26.

As described above, when liquids are removed from sealed containers, it is sometimes desirable to replace the liquid with air as it is being extracted to prevent formation of a vacuum in the container. To accomplish this goal, a needle, or other piercing device can be uses to puncture the top pierceable septa 26 to vent of each of the containers 20 to the atmosphere. For example, as shown in FIG. 2A, after the containers 20 have been loaded in to the frame 40, the cover 50 can be closed and needles 80 disposed in the cavities 52 penetrate the top pierceable septa 26. When an array of needles 80 such as this are used to pierce the septa 26, it can be difficult to puncture the septa 26 at the same time because of the hinging action of the cover 50. In addition to utilizing relatively short needles 80 to prevent accidental sticks, shorter needles 80 also help ensure that all of the needles 80 make contact with the septa 26 at approximately the same time. However, the needles 80 still need to be long enough to adequately puncture the septa 26 so a vacuum doesn't form in the container 20 as the liquid is withdrawn.

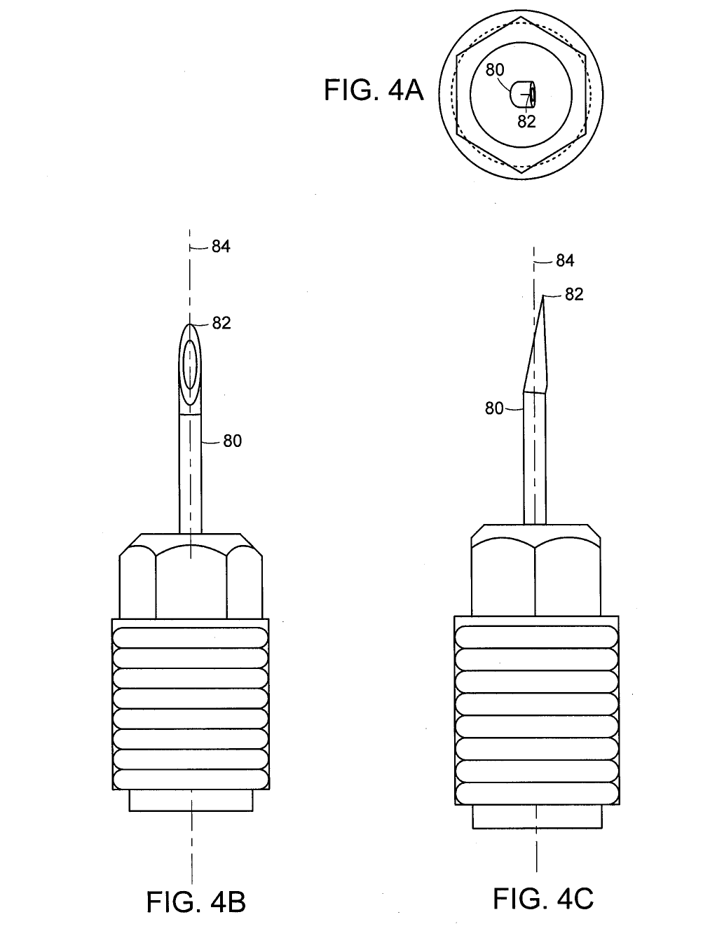

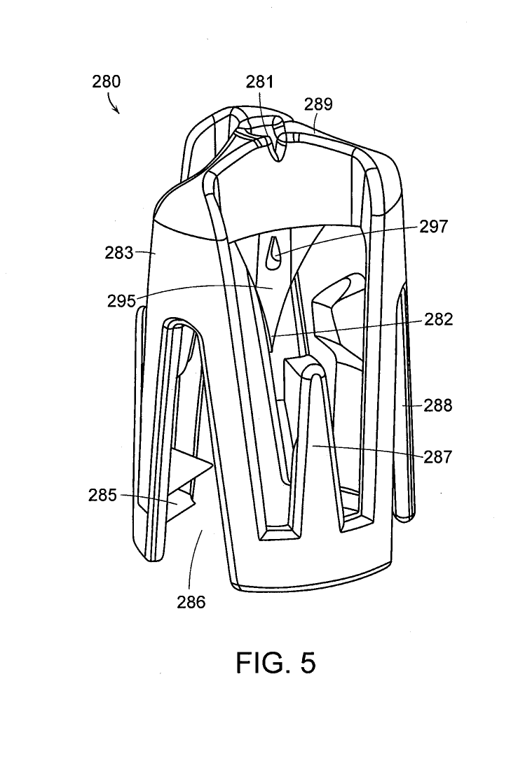

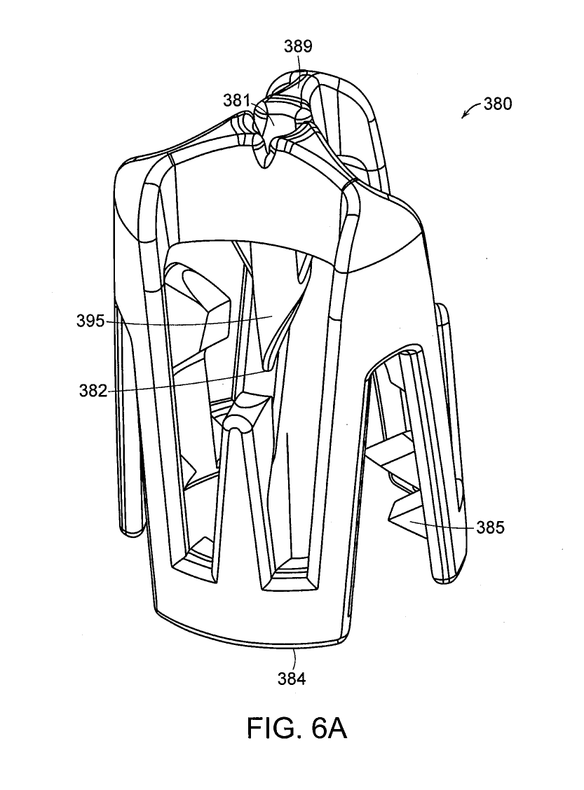

One example of a needle that can be used in the upper array of needles 80 is shown in FIGS. 4A-4C. The deflected tip needle 80 has a sharpened point 82 that is slightly bent or offset from the longitudinal axis 84 of the needle 80. This deflected tip design provides a “non-coring” needle such that as the septum 26 is pierced, none of the septum 26 material is removed, which could potentially cause an obstruction. Each needle 80 has a passageway 81 allowing gas to flow into the container 20 to occupy the space created by withdrawal of liquid reagent volumes. Alternatively, the upper needles 80 can be any type of needle including, for example, a thoracentesis needles, Veress needles, Huber needles, or Trocar needles. The needles 80 can be fabricated from stainless steel, titanium or other similarly rigid material in a range of sizes and lengths depending on the requirements of a particular application.

Even though the needles 80 are disposed in the cavities 52 such that their points 82 are below the bottom surface 54 of the cover 50, these “semi-exposed” needles can still inadvertently poke or stick the finger of a user. Also, since the needles 80 are integral with the cover 50, it may be necessary to clean the needles 80 periodically to ensure that the containers are vented with an uncontaminated venting mechanism. As an alternative to an upper array of needles 80, an individual piercing device can be affixed to the top end of each bottle to vent the containers.

Referring now to FIG. 5, a piercing device 280 for use with a fluidic system and apparatus of the present invention is shown. The piercing device 280 performs substantially the same function as the needles 80 described above, and therefore like reference numerals preceded by the numeral “2” are used to indicate like elements.

FIG. 5 illustrates a piercing device 280 that can be used to puncture the septum 26 of a container allowing gas to flow into the container to occupy the space created by withdrawal of the liquid reagent. As shown, the piercing device 280 includes a housing 283 that defines an internal region 286 configured for receiving a container. One or more slots 288 extend longitudinally from the receiving end of the housing 283 to allow slight expansion of the housing. The receiving end of the housing 283 can have in internal diameter equal to or slightly smaller than the diameter of the container prior to insertion of the container. The slots 288 allow for slight expansion of the housing 283 sufficient to allow insertion of the container, while maintaining a secure fit of the device 280 on the container.

The housing 283 also includes one or more protrusions 285 extending into the interior region 286 of the housing 283. The protrusions 285 assist in positioning and retaining the container within the housing. Additionally, the protrusions 286 provide support and assist in positioning as the device 280 is actuated to pierce the septum of a container.

The housing 283 can also include one or more fingers 287 to assist in positioning and/or selectively retaining the container within the housing 283. As shown, the fingers 287 extend longitudinally away from the receiving end and are positioned within an aperture of the housing 283. The fingers 287 can be used independently from, or in conjunction with the slots 288 to assist in positioning and retaining the container within the housing 283. For example, in an alternative embodiment, the housing does not include any slots and the receiving end of the housing has an internal diameter that is slightly larger than the diameter of the container. In this embodiment, the fingers 287 position and securely retain the container within the housing 283.

The piercing device 280 also includes a base surface 289 opposite from the receiving end. A piercing element 295 extends away from the base surface 289 into the interior region 286 of the housing 283 and defines a passageway 281. As shown, the piercing element 295 tapers to a closed pointed tip 282 and the opening 297 to the passageway 281 is positioned on the side of the piercing element 295. In order to properly vent the container to the atmosphere, the pointed tip 282 has to pierce the septum and protrude into the container a sufficient distance such that the opening 297 to the passageway 281 is passes through the septum and remains inside the container.

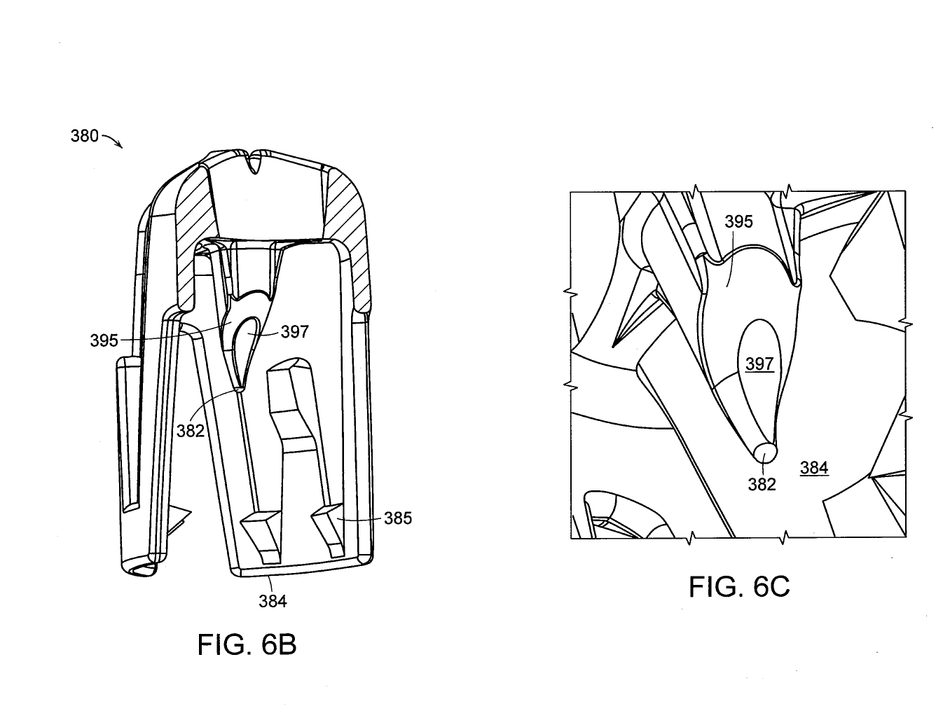

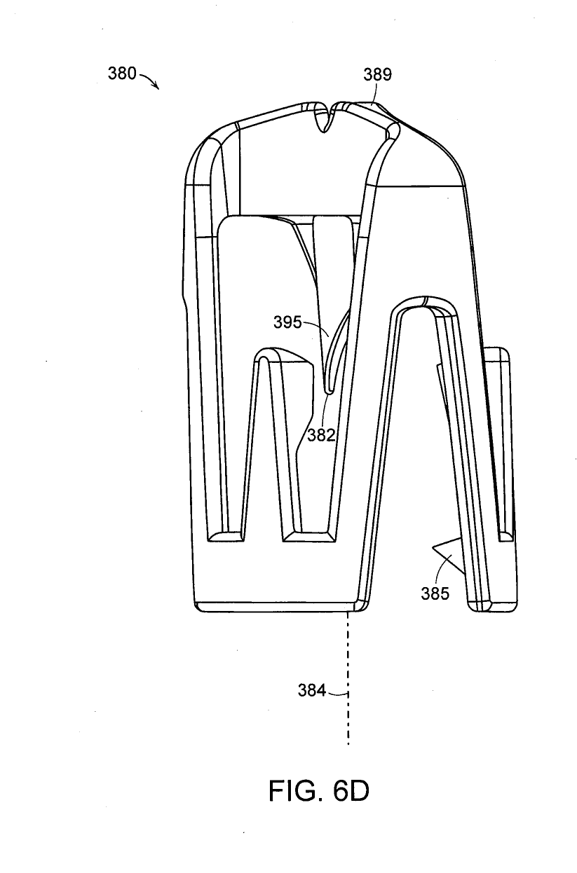

Referring now to FIGS. 6A-6D, an alternative embodiment of a piercing device 380 for use with a fluidic system and apparatus of the present invention is shown. The piercing device 380 performs substantially the same function as the piercing device 280 described above, and therefore like reference numerals preceded by the numeral “3” are used to indicate like elements.

The piercing device 380 shown in FIGS. 6A-6D is substantially the same as the piercing device 280 shown in FIG. 5 with a slightly different piercing element. As shown best in FIG. 6D, the piercing element 395 is tapered on a bias such that the pointed tip 382 is offset from the longitudinal axis 384 of the piercing element. In this embodiment, the opening 397 to the passageway 381 extend along the longitudinal axis 384 from the base surface 389 to the pointed tip 382 such that the opening essentially begins at the pointed tip 382. One advantage of this embodiment is that an open fluid passageway 381 is established almost immediately after the septum of a container is punctured.

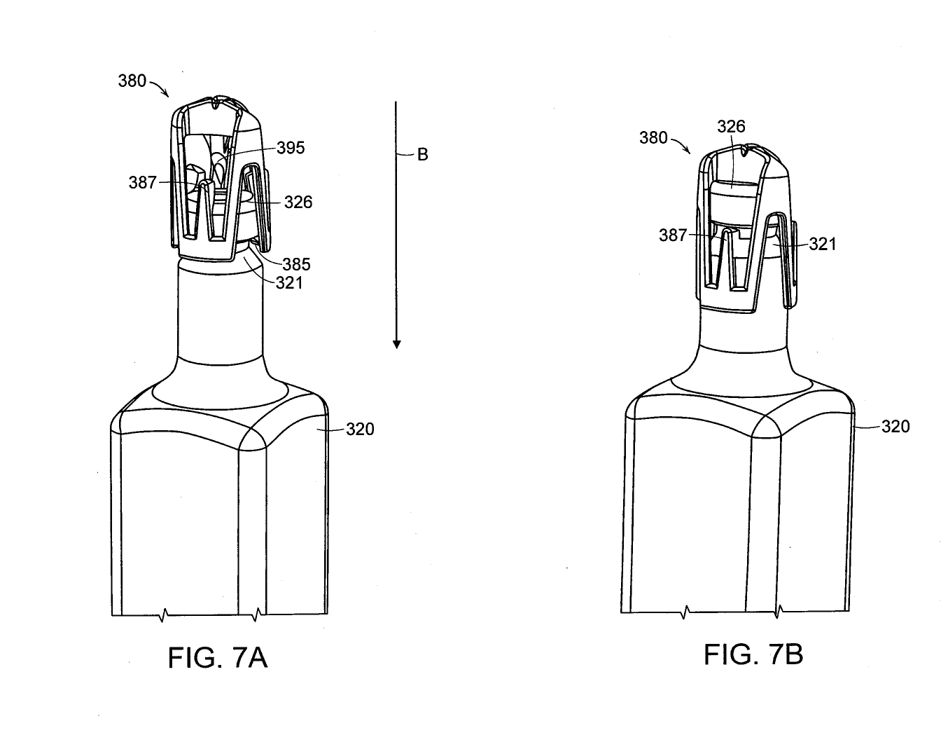

It is envisioned that the piercing device 280, 380 could be easily attached to a container by the user. However, in some instances, the piercing device can be pre-install to the top end of each container and would be discarded with the container 220 after the liquid reagent is utilized. Referring now to FIGS. 7A and 7B, the piercing device 380 is shown attached to the top end of a container 320. As shown in FIG. 7A, the piercing device 380 is movably attached to the end of the container 320 in a un-actuated position. In this un-actuated position, the piercing element 395 is not in contact with the septum 326 and the container 320 is still sealed. The protrusions 385 are disposed in a groove 321 in the top end of the container 320 to secure the device 380 on the container 320. Fingers 387 extend beyond the top end of the container 320 and help prevent inadvertent penetration of the septum by the piercing element during shipping or handling.

To pierce the septum of the container 320, the user pushes down on the piercing device 380 in the direction indicated by line B to actuate the piercing device 380 causing the piercing element 395 to pierce the septum 326 and vent the container 320 to atmosphere. Alternatively, the cover 50 of a liquid storage apparatus 10 described above can actuate a plurality of piercing devices 380 when the cover 50 is closed. FIG. 7B shows the piercing device 380 in the actuated position. Once manipulated into the actuated position, the fingers 387 engage the groove 321 and secure the piercing device 380 into the actuated position and remain in the actuated position even after the user removes their finger or opens the cover 50.

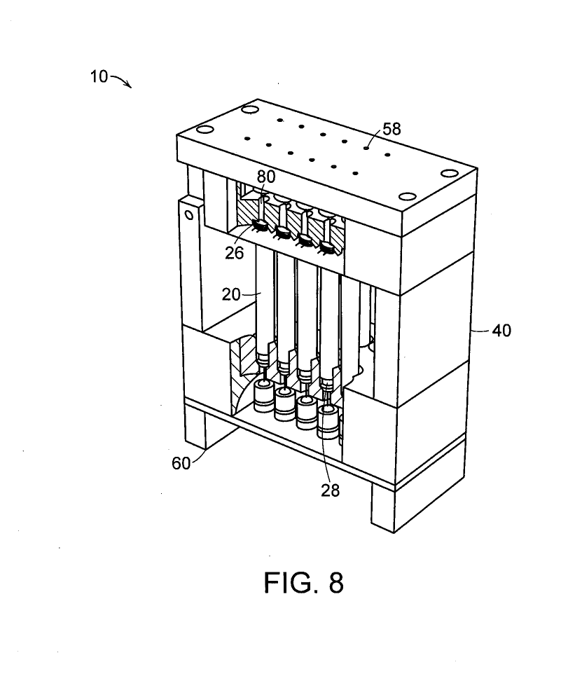

Referring now to FIG. 8, a fully loaded liquid storage apparatus 10 is shown. A series of air vents 58 are fluidly coupled to the passageways 81 of the needles 80 or piercing devices, which allow direct venting of the containers 20 to the atmosphere. As the liquid reagents are withdrawn from the containers 20, air can freely enter the containers 20 through the passageways to replace the liquid volume as it is removed. Replacing the space occupied by the liquid with air or other gas maintains a consistent operating pressure in the containers 20, i.e., no vacuum build-up, thus helping prevent dispensing errors at selector valves in the liquid handling system.

Liquid reagents used in some microfluidic systems have toxic vapors or have an unpleasant odor. The air vents 58 can be fluidly coupled to a filter (not shown) such as a biological grade filter or to a laboratory ventilation system to eliminate the odors or toxic vapors. In further embodiments, the liquids being stored may be extremely volatile in which case a one way check valve or a series of check valves may be included to allow air to flow into the containers after liquid is withdrawn. In yet a further embodiment, certain reagents may be reactive with oxygen and therefore the air vents 58 may be fluidly coupled to an inert gas system to prevent the reagents from degrading.

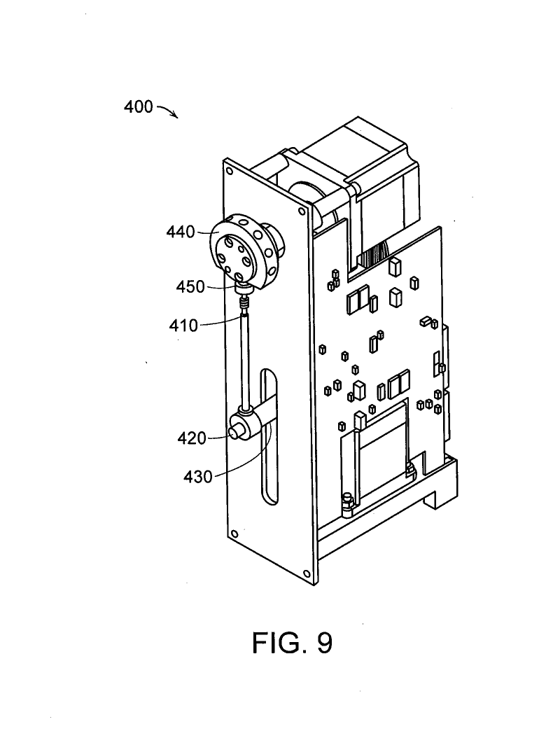

Referring no to FIG. 9, a syringe pump system 400 for withdrawing, mixing, and delivering liquid volumes is shown. The syringe pump system 400 includes a syringe 410 having a plunger 420. The plunger 420 is coupled to a plunger actuator 430 that mechanically moves the plunger 420 up and down to fill and evacuate fluid in the syringe 410. The syringe 410 is fluidly coupled to a reagent selector valve 440 via a syringe port orifice 450, which is in turn fluidly coupled to the liquid reagent containers. The selector valve 440 has a plurality of inlets (not shown), each of the inlets corresponding to one of the liquid reagent containers, and one or more outlets (not shown) corresponding to one or more piece of analytical equipment. The selector valve 440 controls the flow of liquid reagents into the syringe 410 and distribution of the liquid mixture out to analytical equipment.

In operation, the selector valve 440 is set to a particular reagent. The plunger 420 is then pulled down by the actuator 430 creating a pressure drop drawing a predetermined volume of liquid from a specific reagent container, through a conduit, through the selector valve 440, and into the syringe 410. The selector valve 440 can then be changed to an outlet port and the plunger 420 is actuated in an upward direction thereby discharging the liquid to the analytical equipment.

Alternatively, some assays require a combination of several different liquid reagents. In this instance, the selector valve 440 can be set to a particular inlet port corresponding to a certain reagent such as, for example, Reagent 1. The plunger 420 is then actuated drawing a predetermined volume of Reagent 1 into the syringe 410 as described above. The selector valve 440 is then changed to a different inlet port corresponding to a different reagent such as, for example, Reagent 2. The plunger 420 is then actuated drawings a predetermined volume of Reagent 2 into the syringe 410. Once the two reagents are in the syringe 410 they essentially form a mixture of Reagents 1 and 2, which can then be dispensed to the analytical equipment as described above.

Furthermore, in some assays, the plurality of reagents must be sufficiently well mixed to form a relatively homogeneous solution. There are several factors that effect mixing performance including, for example, viscosity of each reagent, volumes of each reagent, miscibility of reagents, total volume to be mixed, and geometry of the syringe. Several fluid dynamic phenomena occur within the syringe pump system 400 that are highly effective at promoting sufficient mixing such as cavitation and turbulence. For example, when the plunger 420 is pulled down very quickly, a significant pressure drop is generated at the orifice 450 of the syringe 410. This pressure drop depends on the size of the orifice 450, the diameter of the syringe 410, the speed of the plunger 420 movement, and the total change in volume of the syringe 410. This inertial cavitation provides a low pressure void into which the fluid flows causing increased mixing through the eddies and vortices occurring at the interface between the void and the liquid.

During the mixing process, if Reynolds numbers greater than 1,000 can be achieved creating transitional flow, or better still, greater than 2,000 creating turbulent flow, mixing will occur throughout the syringe 410 volume. However, with lower velocities and therefore lower Reynolds numbers, the cavitation and layering of reagents also can provide effective mixing. For layering of reagents, small volume reagents should generally be added in between layers of the highest volume reagents. The highest volume reagents are added at higher flow rates to create Reynolds numbers in excess of 2,500. Furthermore, it may be necessary to add an individual reagent to the syringe 410 multiple times stacking them up in the syringe 410 and disturbing them during the filling/mixing process several times as the formulation is prepared to ensure proper mixing. One reason for “stacking” certain reagents is to avoid damaging the reagents by localized heating and/or shock waves caused by cavitation. One example of such stacking of reagents is provided in Example 1 below.

### EXAMPLE 1

| | Volume | Aspiration Speed |
|---|---|---|
| Reagent | (μL) | (μL/second) |
| Water | 22.5 | 250 |
| Reagent 1 | 12 | 20 |
| Reagent 2 | 12 | 15 |
| Reagent 3 | 6 | 10 |
| Water | 20 | 250 |
| Reagent 4 | 6 | 20 |
| Water | 20 | 250 |
| Reagent 1 | 10 | 20 |
| Reagent 2 | 10 | 15 |
| Reagent 3 | 5 | 10 |
| Water | 20 | 250 |
| Reagent 4 | 6 | 20 |
| Water | 20 | 250 |
| Reagent 1 | 10 | 20 |
| Reagent 2 | 10 | 15 |
| Reagent 3 | 5 | 10 |
| Water | 9.7 | 250 |
| Reagent 4 | 6 | 20 |
| Water | 39.8 | 250 |

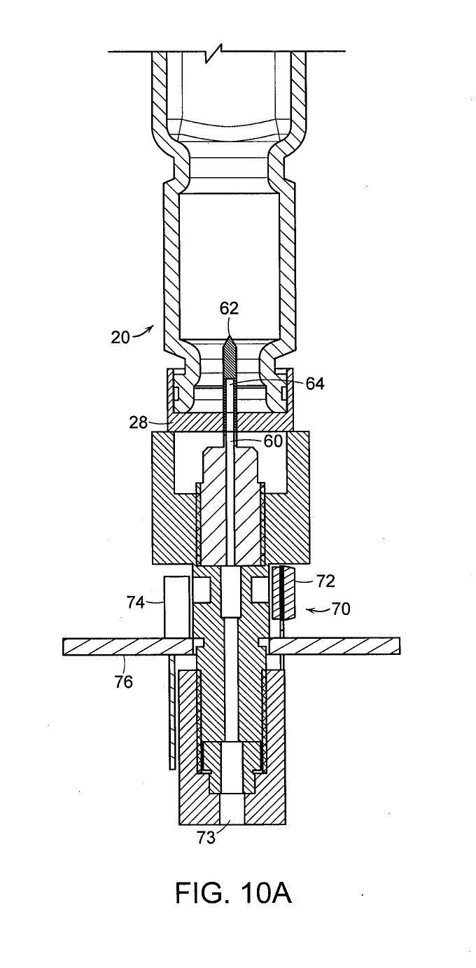

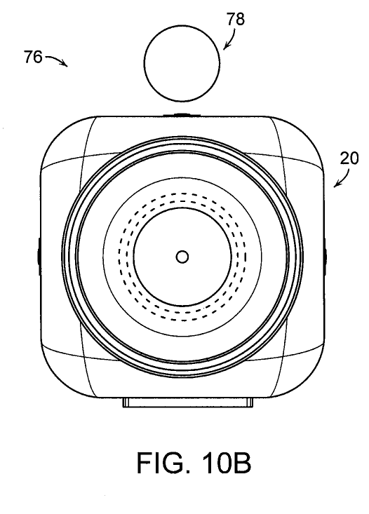

Analytical equipment utilizing liquid reagents can be damaged if gasses are allowed to enter the liquid handling system. One way of preventing this damage is to provide liquid level sensors for the entire apparatus or a level sensor at each individual container. Referring now to FIGS. 10A and 10B, the liquid storage apparatus 10 further includes a liquid level sensor 70. As shown in FIG. 10A, the liquid level sensor 70 includes a photo sensor 72 and a light-emitting diode (LED) 74. The liquid level sensor 70 is positioned on a circuit board 76 below each of the containers 20 along the flow path between the aperture 64 of the lower needle 60 and the outlet 73 to the liquids handling system. The photo sensor 72 is located on the opposite side of the flow path from the LED 74. This type of liquid level sensor 70 is known as an optical level sensor and can sense the presence or absence of fluid bases on the light transmitted from the LED 74 thought the flow path. Other types of liquid level sensors that can be used with the liquid storage apparatus 10 include, for example, ultrasonic level sensors and capacitance level sensors.

The liquid level sensors can be configured to shut down the equipment when the liquid in the containers has been fully utilized or to provide notification to the user when the liquid level is either getting low or is completely empty. As shown in FIG. 10B, a LED 78 is attached to the circuit board 76 next to the container 20. The LED 78 provides a visual indication to the user when that particular container 20 is empty. The LEDs may also be configured to provide a visual indication of where certain containers 20 should be loaded for particular experimental procedures.

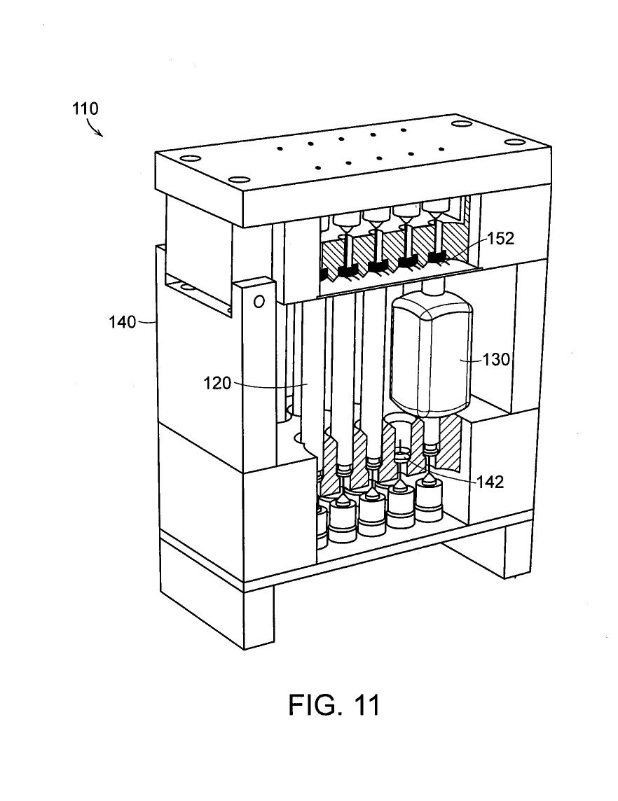

As shown in FIGS. 1, 2, and 8, all of the containers 20 are the same size and shape. Referring now to FIG. 11, a liquid storage apparatus 110 is shown with one container 130 larger than the other containers 120. The tops and bottoms of all of the containers 120, 130 are symmetrical having the same size and shape. The top and bottom cavities 142, 152 are also the same size and shape such that the containers 120, 130 can be loaded in either direction. This universal interface design allows a variety of different container sizes to be used in the liquid storage apparatus 110. In alternative embodiments, the tops and bottoms of the bottles 120, 130 and the top and bottom cavities 142, 152 are not all symmetrical (i.e., different sizes and shapes) which can prevent liquid reagents from being loaded in the wrong location.

As mentioned above, the liquid storage apparatus 110 of the present invention is designed for a wide variety of applications. In certain applications, such as single sequencing of DNA molecules, the liquid reagents can be very expensive. The user can customize the liquid storage apparatus 110 with larger containers for reagents that are used more frequently and smaller containers for those reagents that are used less frequently or in smaller quantities. Additionally, container cartridge assemblies can be designed for specific applications so that the liquid in each container of the assembly is used up at approximately the same time.

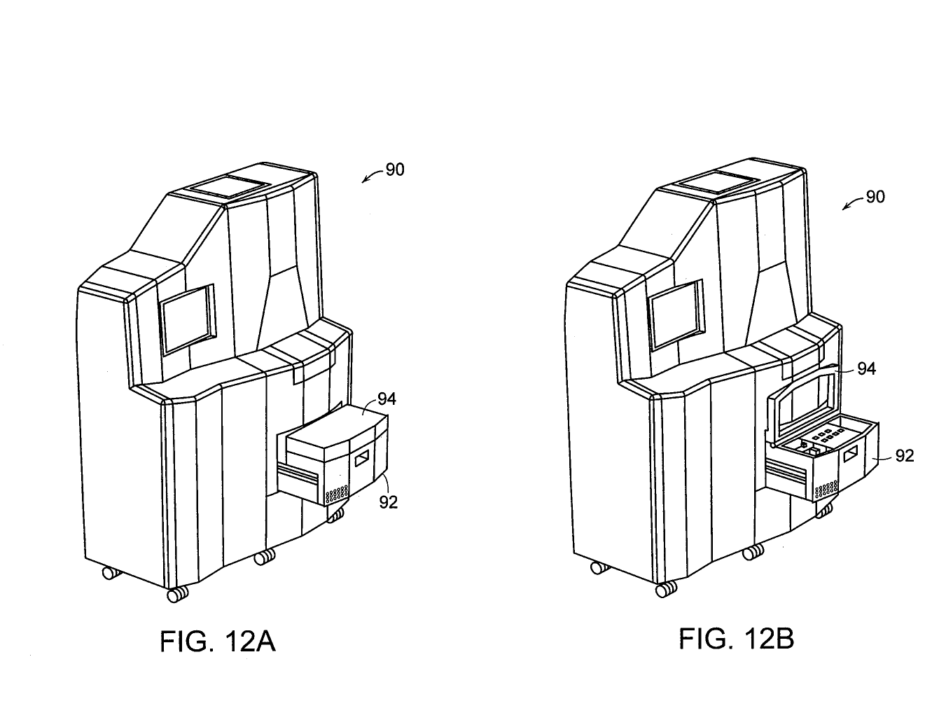

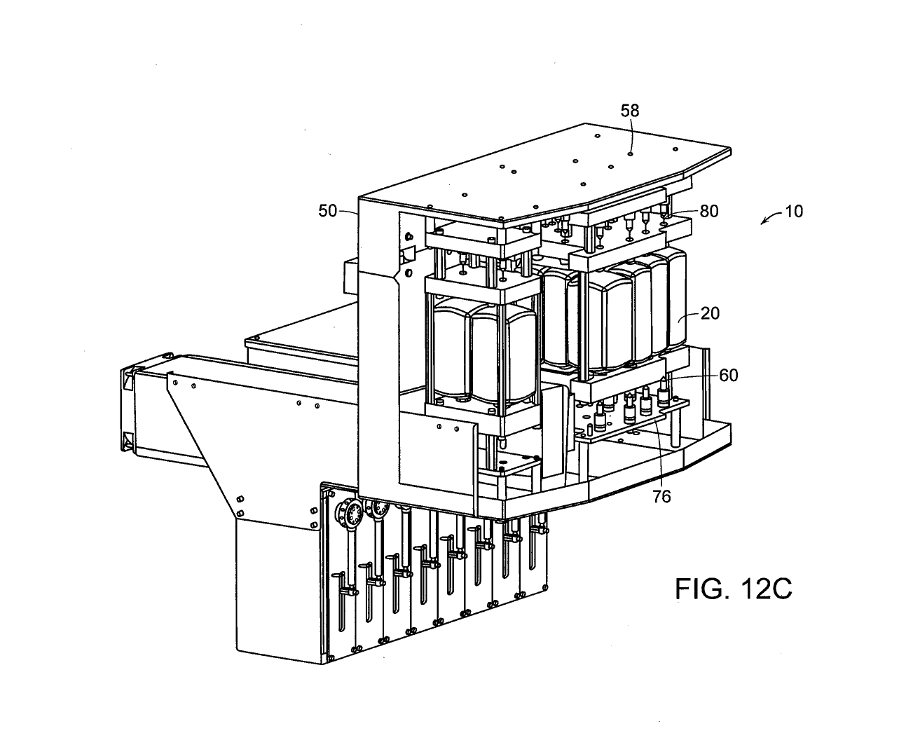

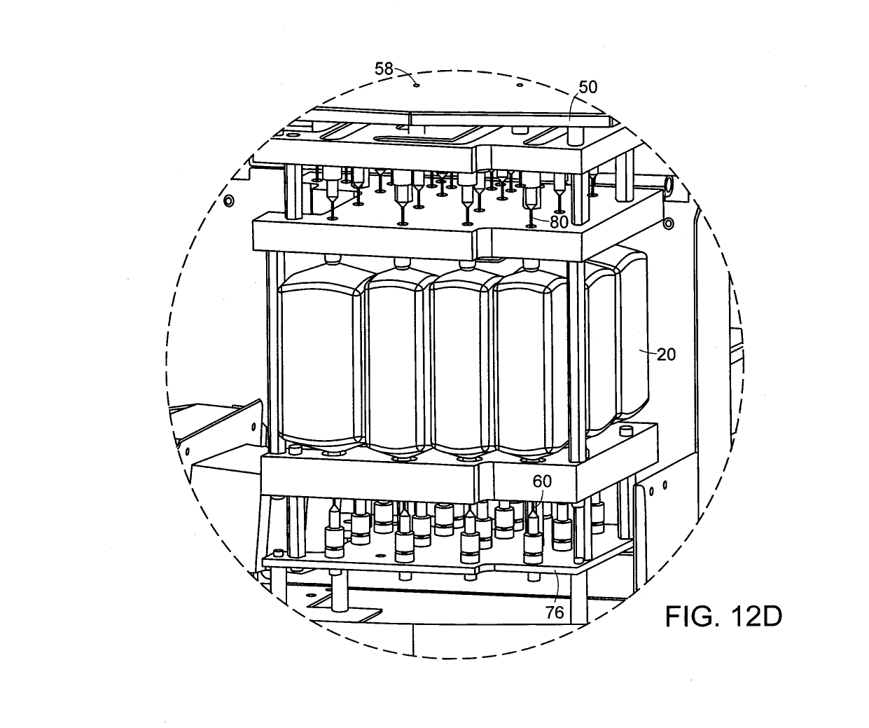

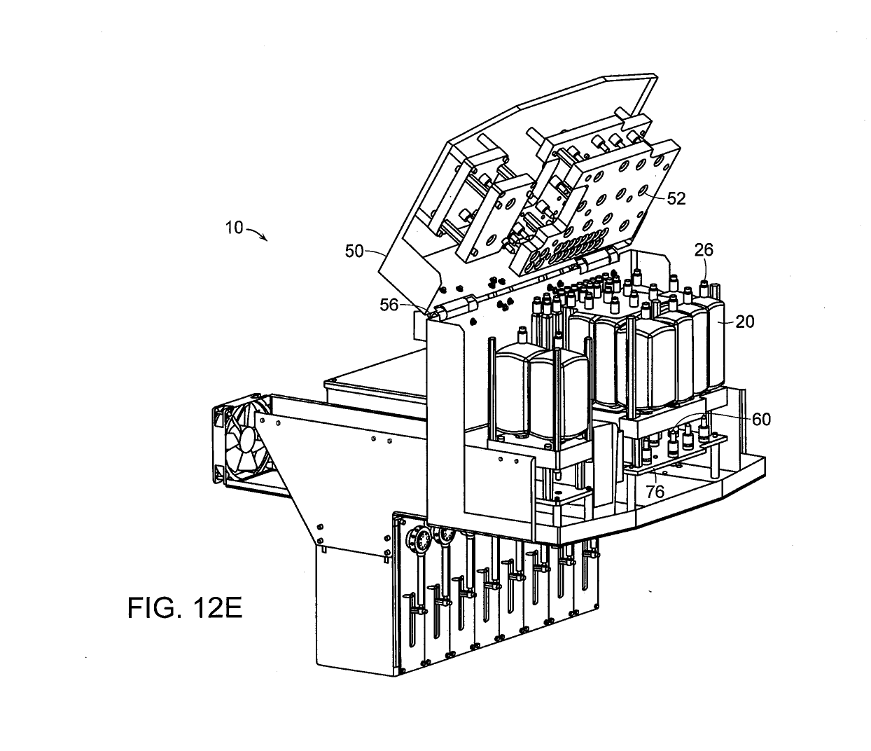

The liquid storage apparatus 10 can be a stand-alone apparatus that can be connected to a variety of lab equipment or it may be integrated into an individual piece of equipment. Referring now to FIG. 12A-12E, the frame 40 is integrated into a compartment of a single molecule sequencing device 90. To load the reagents, the user simply slides open the compartment 92 and opens the cover 94. Individual containers and/or cartridge assemblies are inserted into the appropriate locations. The liquid storage compartment 92 may be subdivided to store liquids at different temperatures.

The disclosed embodiments are exemplary. The invention is not limited by or only to the disclosed exemplary embodiments. Also, various changes to and combinations of the disclosed exemplary embodiments are possible and within this disclosure.

1. A liquid storage apparatus for use in connection with microfluidic volume analyzing equipment, comprising:
a plurality of containers, each container comprising a top pierceable septum and a bottom pierceable septum;
a lower array of needles, each of the lower needles for penetrating the bottom pierceable septum of a different one of the containers; and
a piercing device for penetrating the top pierceable septum, each piercing device including a passage through which a gas flows into the container.

2. The liquid storage apparatus of claim 1, wherein the piercing device further comprises:
a housing defining an internal region for receiving a container having a pierceable septum, the housing having one or more slots to allow expansion of the housing;
a septum piercing element affixed to the housing, the septum piercing element having a pointed tip and defining a passageway; and
a protrusion for selectively engaging an outer surface of the container,
wherein the protrusion positions and retains the container in the housing in an un-actuated position such that the septum piercing element is not in contact with the septum prior to manipulation

3. The liquid storage apparatus of claim 2, wherein the piercing device further comprises:
a finger for selectively securing the container in the housing.

4. The liquid storage apparatus of claim 3, wherein the finger engages the outer surface of the container and secures the container in the housing in an actuated position such that the septum piercing element pierces the septum of the container after manipulation.

5. The liquid storage apparatus of claim 2, wherein the housing is manipulated from the un-actuated position to an actuated position such that the piecing element in the actuated position pierces the septum.

6. A piercing device comprising:
a housing defining an internal region for receiving a container having a pierceable septum, the housing having one or more slots to allow expansion of the housing;
a septum piercing element affixed to the housing, the septum piercing element having a pointed tip and defining a passageway; and
a protrusion for selectively engaging an outer surface of the container,
wherein the protrusion positions and retains the container in the housing in an un-actuated position such that the septum piercing element is not in contact with the septum prior to manipulation

7. The piercing device of claim 6, furthering comprising a finger for selectively securing the container in the housing.

8. The piercing device of claim 7, wherein the finger engages the outer surface of the container and secures the container in the housing in an actuated position such that the septum piercing element pierces the septum of the container after manipulation.

9. The piercing device of claim 6, wherein the housing is manipulated from the un-actuated position to an actuated position such that the piecing element in the actuated position pierces the septum.

10. The piercing device of claim 9, wherein the passageway is in fluid communication with the container.
